(19) United States
(12) Patent Application Publication
(10) Pub. No.: US 2016/0117900 A1
(43) Pub. Date: Apr. 28, 2016

(54) METHODS FOR DETECTING FIRES IN BIOMASS STORAGE SYSTEMS

(71) Applicant: Ian Hibbitt, Hognaston (GB)

(72) Inventor: Ian Hibbitt, Hognaston (GB)

(21) Appl. No.: 14/524,506

(22) Filed: Oct. 27, 2014

(51) Int. Cl. G08B 17/10

(52) U.S. Cl. CPC G08B 17/10

(57) ABSTRACT

A method for detecting a fire event in a biomass storage system containing biomass is performed by continuously measuring the humidity in the biomass storage system; comparing the measured humidity to a pre-defined humidity and if the difference between the measured humidity and the pre-defined humidity exceeds a pre-determined amount, providing an alert to an operator.

### BACKGROUND OF THE INVENTION

The present invention relates to the use of humidity sensors in a biomass storage system to detect the presence of a pyrolysis event or fire event in a biomass pile present in the biomass storage system.

The burning of biomass as a fuel in power stations has become more prevalent in recent years and the volume of biomass used and stored at power stations has correspondingly increased. In general terms, biomass comprises plant matter which is shredded and compacted into pellets. The pellets are stored in large silos prior to being conveyed for use in the boilers. Such silos can range from hundreds of cubic meters in volume to thousand of cubic meters. A typical source of biomass plant matter is wood and the following description is given in the context of wood biomass. However, the invention applies equally to other types of biomass and to other types of flammable materials.

Not only are biomass pellets stored in large silos, but so too is biomass dust which is generated from the pellets during storage and handling. The dust is drawn off in an air stream which is filtered to remove the dust. The dust is then pneumatically conveyed to dust silos where it is stored prior to being burnt in the boilers.

Fires may occur in both biomass pellet storage silos and dust storage silos, and the factors which cause fires in both cases are broadly the same. Fires in biomass storage silos can come about as a result of bacterial and fungal activity which generate heat and produce methane, carbon monoxide and carbon dioxide. Heat accumulates to over 50° C. leading to thermal oxidation of the wood. As the temperature continues to rise, dry matter is lost, fuel quality deteriorates and eventually the biomass ignites. The reactions are fed by water, oxygen and carbon dioxide.

Although water is the best medium for removing heat from smoldering fires, the use of water sprinklers would cause damage to the silos and cause wood dust to set, resulting in large costs and downtime. It is known in the art that smoldering fires can be controlled and extinguished by providing an inert atmosphere within the silo. This is commonly achieved by providing a carbon dioxide or nitrogen atmosphere within the silo.

The present invention provides for the detection of fires in biomass storage systems which will initiate a fire suppression system to suppress the fire before it grows and causes harm within the storage system,

The initiation of a pyrolysis event or fire within the biomass store will result in the production of gases such as carbon monoxide, carbon dioxide and hydrogen as well as significant quantities of water in the gas phase. By measuring for these gases, the pyrolysis event or fire can be detected and methods to suppress the pyrolysis event or fire can be activated.

### SUMMARY OF THE INVENTION

In one embodiment of the invention, there is disclosed a method for detecting a fire event in a biomass storage system containing biomass comprising continuously measuring the humidity in the biomass storage system; comparing the measured humidity to a pre-defined humidity and if the difference between the measured humidity and the pre-defined humidity exceeds a pre-determined amount, providing an alert to an operator.

In another embodiment of the invention, there is disclosed a method for detecting a fire event in a biomass storage system comprising continuously measuring the humidity in the biomass storage system, comparing the measured humidity to a pre-defined humidity and initiating a fire suppression system.

For purposes of the present invention, a “fire event” is defined to include a pyrolysis event, a fire or a fire that is just about to start.

The humidity in the biomass storage system is measured continuously and the amount of humidity will vary over time due to importing new batches of biomass into the system. When a fire event occurs, there will be an increase in the rate of change of the humidity in the biomass storage system which will be detected by the humidity sensor. The humidity sensor will communicate electronically with a programmable logic controller which will interpret this humidity change rate data and determine if a fire event is occurring and initiate the appropriate suppression system.

The humidity detector may be a mirror dew point system.

More than one humidity detector can be employed in the biomass storage system. By using a plurality or an array of humidity sensors, the rate of humidity change can be calculated to enable the position of the fire event within the biomass storage system to be detected thereby improving the efficiency of the use of the suppression system.

The biomass storage systems that are employed in the invention are used for storing biomass. Biomass is biological material derived from living or recently living organisms. Biomass typically includes virgin wood, energy crops, agricultural residues, food waste and industrial waste and co-products.

The biomass storage system is typically a silo. The biomass storage system has a base with a plurality of gas net ports for the introduction of a gas into the biomass storage system during use. These gases can be the fire retardant gas that can be used to prevent, control and suppress fires within the storage system such as carbon dioxide and nitrogen. The plurality of gas inlet ports allows the operator the ability to use some but not all of the ports when introducing gas thereby saving on cost and reduced wastage of gas.

The gas inlet ports may be substantially evenly spaced over the base of the storage system to ensure even distribution of gas within the storage system in use and to allow focused gas injection to a specific area of the storage system if required, for example, upon detection of a localized fire event within the storage system.

The storage system also comprises at least one sidewall which will also comprise a plurality of gas inlet ports for the introduction of a gas into the biomass storage system during use. This further allows the fire retardant gas to be introduced into the storage system via the sidewalk as well as via the base.

A gas permeable protective housing may be provided over at least some of the gas inlet ports to protect the gas inlet ports and inhibit blockages,

When the operator receives notification of a fire event, a fire retardant gas may be inputted into the biomass storage system manually. This process may be automated as well depending upon the needs of the individual biomass storage system.

In a further embodiment of the invention, the method comprises detecting a fire event by way of an increase in humidity measured within a biomass storage system. Once detected, the operator can start a fire suppression system which will inject through at least one gas inlet a gas which will cover the biomass with a layer of the gas sufficient to suppress smoke and extinguish the fire.

### BRIEF DESCRIPTION OF THE DRAWINGS

FIG. 1 shows a schematic diagram of a biomass storage system such as a silo.

### DETAILED DESCRIPTION OF THE INVENTION

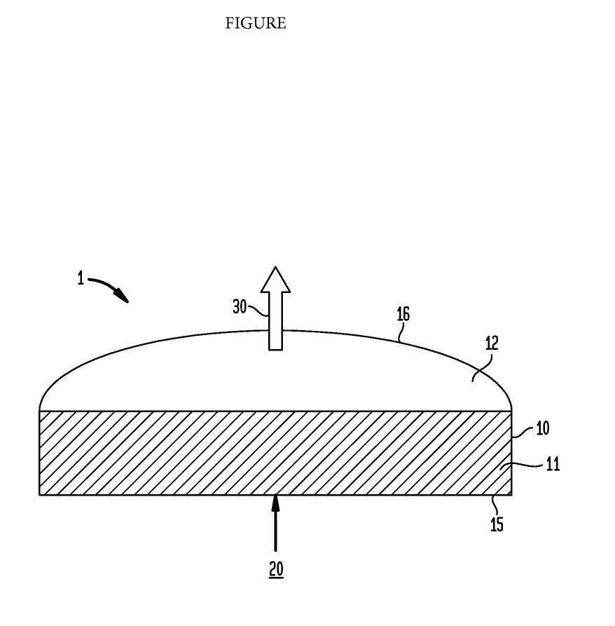

Biomass storage systems such as silos can range from hundreds of cubic meters in volume to thousands of cubic meters in volume. For instance, turning to FIG. 1, a biomass storage silo 1 has a generally cylindrical shape comprising a substantially circular base 15, substantially vertical sidewalls 10 and a domed roof 16. In this example, the biomass silo 1 has a diameter of 60 meters, a sidewall height of 20 meters, and an overall height of 50 meters. However, this is merely one example and other sizes, shapes or configurations of storage systems or silos are contemplated for use of the invention depending on the needs of the particular locations and applications.

The silo 1 contains a pile of biomass 11 having an average diameter of 6 millimeters and an average length between 8 and 15 millimeters. The silo 1 is arranged for first in first out usage system for the biomass to reduce the residence time and thereby reduce the risk of the factors accumulating which can cause fires. Under normal use conditions, when there is no fire event detected and no conditions detected which are indicative of a fire breaking out, nitrogen gas of between 90% and 99% purity is introduced into the base of the silo via gas inlet ports 20 which are spaced over the base 15 of the silo 1. The inlet ports 20 are generally evenly spaced in a grid pattern over the base 15, The gas inlet ports 20 may optionally be covered by a protective housing (not shown) to inhibit damage and blockages of the gas inlet ports. These protective housings could be used on all or some of the gas inlet ports. The protective housing (if present) is made of a gas permeable material (including, but not limited to, a substantially solid/rigid material having sufficient holes to allow the fire retardant gas to pass through).

In order to maintain a sufficiently fire retardant atmosphere within the silo, while controlling the amount of nitrogen gas used, the introduction of the nitrogen gas into the silo is controlled so that only a portion of the gas inlet ports 20 are in use at any one time. This process is controlled by a programmable logic controller (not shown) which is programmed according to the operating needs of the silo such as for example, the fill level, time since last injection, amount of material being recovered and from where, and the age of the biomass in the silo. The programmable logic controller may be programmed to operate the gas inlet ports 20 in sequence such that each set of ports operates for a selected period of time, for example, from 1 to 10 hours, and/or to deliver a selected amount of nitrogen gas into the silo before being shut off and the next set of gas inlet ports 20 in the sequence being activated. Alternatively, the programmable logic control may be programmed to activate the gas inlet ports 20 randomly.

The nitrogen gas introduced into the silo 1 rises up through the biomass pile 11 in accordance with the well known principles of fluid flow through packed beds, As the gas rises it collects reaction produces such as water, methane, carbon dioxide and carbon monoxide which are generated in the biomass pile during storage. The nitrogen and collected reaction products eventually reach the headspace 12 of the silo 1 and vent to the atmosphere.

A plurality of humidity detectors are distributed through the storage space within the silo 1. The humidity detectors may be mounted in the base 15 of the silo or they may be mounted on the sidewall 10 or they may be mounted in both the base 15 and sidewall 10 of the silo 1.

The humidity detectors are in electronic communication with the programmable logic controller and feedback information relating to the humidity levels within the silo 1 to the programmable logic controller. In the event that a fire event occurs, the humidity levels within the silo 1 are expected to rise. The humidity detectors will continuously measure the humidity levels within the silo 1 and send this information to the programmable logic controller. When the measured humidity is compared to a pre-defined humidity, which is typically a base level humidity level for a biomass pile, and the difference exceeds a pre-determined amount, then the programmable logic controller will signal that a fire event is occurring and alert the operator to the event. The operator can then initiate a fire suppression system which will inject flame retardant gas into the silo 1 through the necessary number of gas inlet ports 20. In certain instances, the fire suppression system can operate automatically in reaction to the signal that a fire event is occurring inside the silo.

The advantage of directing the flow of fire suppression gas through gas inlets 20 is that the gas will contact the biomass pile below the fire event and concentrates it on the fire event. Oxygen concentration is reduced and there will be some cooling associated with the focused flow of fire suppression gas. The biomass contains sufficient bound oxygen to keep a smoldering fire going even in inerted conditions within the silo. The focused use of the inert gas will improve the heat removal at the fire site thus helping extinguish the fire by temperature reduction.

While this invention has been described with respect to particular embodiments thereof, it is apparent that numerous other forms and modifications of the invention will be obvious to those skilled in the art. The appended claims in this invention generally should be construed to cover all such obvious forms and modifications which are within the true spirit and scope of the invention.

Having thus described the invention, what I claim is:

1. A method for detecting a fire event in a biomass storage system containing biomass comprising continuously measuring the humidity in the biomass storage system; comparing the measured humidity to a pre-defined humidity and if the difference between the measured humidity and the pre-defined humidity exceeds a pre-determined amount, providing an alert to an operator.

2. The method as claimed in claim 1 wherein the biomass storage system is a silo.

3. The method as claimed in claim 1 wherein the silo comprises a base and at least one sidewall.

4. The method as claimed in claim 1 wherein the humidity is detected by a humidity detector.

5. The method as claimed in claim 2 wherein the humidity detector is located in the base or mounted to the at least one sidewall of the silo.

6. The method as claimed in claim 5 wherein the humidity detector comprises a plurality of humidity detectors.

7. The method as claimed in claim 1 wherein the humidity detector is a mirror dew point system.

8. The method as claimed in claim 1 wherein the humidity detector is in electronic communication with a programmable logic controller device.

9. The method as claimed in claim 1 wherein the pre-defined humidity and the pre-determined excess amount are values stored in the programmable logic controller device.

10. The method as claimed in claim 1 wherein the gas is selected from the group consisting of nitrogen and carbon dioxide.

11. The method as claimed in claim 1 wherein the biomass is selected from the group consisting of virgin wood, energy crops, agricultural residues, food waste and industrial waste and co-products.

12. The method as claimed in claim 1 wherein the initiating of inputting a gas into the biomass storage system is performed manually.

13. The method as claimed in claim 1 wherein the initiating of inputting a gas into the biomass storage system is performed automatically.

14. A method for detecting a fire event in a biomass storage system comprising continuously measuring the humidity in the biomass storage system, comparing the measured humidity to a pre-defined humidity and initiating a fire suppression system.

15. The method as claimed in claim 14 wherein the fire suppression system is inputting of a gas into the biomass storage system.

16. The method as claimed in claim 14 wherein the biomass storage system is a silo.

17. The method as claimed in claim 14 wherein the silo comprises a base and at least one sidewall.

13. The method as claimed in claim 14 wherein the humidity is detected by a humidity detector.

19. The method as claimed in claim 15 wherein the humidity detector is located in the base or mounted to the at least one sidewall of the silo.

20. The method as claimed in claim 19 wherein the humidity detector comprises a plurality of humidity detectors.

21. The method as claimed in claim 14 wherein the humidity is measured with a mirror dew point system.

22. The method as claimed in claim 14 wherein the humidity detector is in electronic communication with a programmable logic controller device.

23. The method as claimed in claim 14 wherein the pre-defined humidity and the pre-determined excess amount are values stored in the programmable logic controller device.

24. The method as claimed in claim 14 wherein the gas is selected from the group consisting of nitrogen and carbon dioxide.

25. The method as claimed in claim 14 wherein the biomass is selected from the group consisting of virgin wood, energy crops, agricultural residues, food waste and industrial waste and co-products.
